(19) United States
(12) Patent Application Publication
(10) Pub. No.: US 2026/0338916 A1
(43) Pub. Date: Oct. 29, 2026

(54) RADAR-BASED TRAILER DIMENSION MEASUREMENT USING COHERENT RADAR FRAME ACCUMULATION

(71) Applicant: AUMOVIO Autonomous Mobility US, LLC, Auburn Hills, MI (US)

(72) Inventors: Joseph Burtch, Lake Orion, MI (US); Suraj Goyal, Rochester, MI (US)

(73) Assignee: AUMOVIO Autonomous Mobility US, LLC, Auburn Hills, MI (US)

(21) Appl. No.: 19/649,894

(22) Filed: Apr. 16, 2026

Related U.S. Application Data
(60) Provisional application No. 63/790,097, filed on Apr. 17, 2025.

(51) Int. Cl. G01S 7/41; G01S 13/58; G01S 13/931

(52) U.S. Cl. CPC G01S 7/417; G01S 7/418; G01S 13/58; G01S 13/931; G01S 2013/932; G01S 2013/9322

(57) ABSTRACT

Radar frames from at least one rearward-facing radar sensor mounted on a tow vehicle are accumulated over a plurality of time intervals, aligned using odometry data of the tow vehicle, and coherently processed to provide improved spatial resolution for determining dimensions of a trailer positioned rearwardly of the tow vehicle. A two-dimensional pose of the tow vehicle is estimated by integrating wheel encoder velocity, steering angle, and inertial measurement unit data, and each accumulated frame is back-projected into a common reference frame so that stationary trailer features accumulate coherently. One or more edges or boundaries of the trailer are extracted from the coherently processed frames using a convex hull algorithm or a neural network, and trailer dimensions are determined therefrom and used to at least partly control the tow vehicle during trailering operations.

### CROSS-REFERENCE TO RELATED APPLICATIONS

This application claims priority to U.S. Provisional Patent Application No. 63/790,097, filed Apr. 17, 2025, titled "RADAR-BASED TRAILER HITCH ASSIST SYSTEM AND METHOD," the entire contents of which are incorporated herein by reference. This application is related to co-pending U.S. Patent Application No. 19/649,859, filed concurrently herewith, titled “RADAR-BASED TRAILER DIMENSION MEASUREMENT USING POINT CLOUD CLUSTERING,” the entire contents of which are incorporated herein by reference.

### TECHNICAL FIELD

This disclosure relates to a method and system for determining dimensions of a trailer positioned rearwardly of a tow vehicle using radar sensor data, and for autonomously or semi-autonomously maneuvering or otherwise controlling the tow vehicle based upon the determined trailer dimensions.

### BACKGROUND

Trailers are generally unpowered vehicles towed by a powered tow vehicle. A trailer may be a utility trailer, a popup camper, a travel trailer, a livestock trailer, a flatbed trailer, an enclosed car hauler, a boat trailer, or any other towed cargo carrier. The tow vehicle may be a car, a crossover, a truck, a van, a sports-utility-vehicle (SUV), a recreational vehicle (RV), or any other vehicle configured to attach to and pull the trailer. The trailer is typically attached to the tow vehicle by way of a trailer hitch. A receiver hitch mounted on the tow vehicle connects to the trailer hitch to form a tow connection. The trailer hitch may take the form of a ball and socket, a fifth wheel and gooseneck, a trailer jack, or another attachment mechanism.

Various trailering functions require accurate knowledge of trailer geometry. For example, trailer collision warning and avoidance systems, reverse trailer maneuvering systems, braking coordination systems, and trailer jackknife prevention systems each rely upon accurate knowledge of trailer width and, in some cases, trailer length and the angular relationship—referred to as the trailer angle—between the tow vehicle and the trailer. Ideally, these geometric parameters are available from a cold-start standstill condition before the tow vehicle has begun maneuvering relative to the trailer. Current approaches generally require the driver to manually input trailer width and other parameters, which is inconvenient, error-prone, and time-consuming. There remains a need for systems and methods that automatically and accurately determine trailer dimensions from onboard sensors, without requiring manual driver input.

### BRIEF SUMMARY

In one aspect, a method of determining dimensions of a trailer positioned rearwardly of a tow vehicle comprises: receiving, by data processing hardware, sensor data from at least one radar sensor mounted on a rearward-facing portion of the tow vehicle; accumulating, by the data processing hardware, radar frames based upon the sensor data over a plurality of time intervals; aligning, by the data processing hardware, the accumulated radar frames using odometry data of the tow vehicle; coherently processing, by the data processing hardware, the aligned accumulated radar frames to provide improved spatial resolution; extracting, by the data processing hardware, one or more edges or boundaries of the trailer from the coherently processed radar frames; determining, by the data processing hardware, one or more dimensions of the trailer based upon the extracted one or more edges or boundaries; and at least partly controlling the tow vehicle during a trailering operation based upon the determined one or more dimensions.

In another aspect, a system for determining dimensions of a trailer positioned rearwardly of a tow vehicle comprises: at least one radar sensor configured to be mounted on a rearward-facing portion of the tow vehicle and to generate radar sensor data representing a rearward environment of the tow vehicle; data processing hardware; and non-transitory memory storing instructions that, when executed by the data processing hardware, cause the data processing hardware to perform operations comprising: accumulating radar frames based upon the radar sensor data over a plurality of time intervals; aligning the accumulated radar frames using odometry data of the tow vehicle; coherently processing the aligned accumulated radar frames to provide improved spatial resolution; extracting one or more edges or boundaries of the trailer from the coherently processed radar frames; determining one or more dimensions of the trailer based upon the extracted one or more edges or boundaries; and at least partly controlling the tow vehicle during a trailering operation based upon the determined one or more dimensions.

Various implementations of the foregoing method and system may include one or more of the following optional features. Radar data in the aligned accumulated radar frames may be clustered prior to extracting the one or more edges or boundaries of the trailer. Extracting the one or more boundaries of the trailer may comprise applying a convex hull algorithm to the coherently processed radar frames to determine the boundaries of the trailer. Extracting the one or more edges of the trailer may comprise applying a neural network to the coherently processed radar frames to detect the one or more edges. Coherently processing the aligned accumulated radar frames may comprise applying one or more Fast Fourier Transforms (FFTs) to the accumulated radar frames, comprising at least one of a range FFT, a Doppler FFT, or a combined range-azimuth FFT. Aligning the accumulated radar frames may comprise estimating a two-dimensional pose of the tow vehicle at each frame acquisition time using a sensor fusion estimator that integrates wheel encoder velocity, steering angle data, and inertial measurement unit angular rate data, and back-projecting each accumulated radar frame into a common reference frame using an inverse of a pose change between a reference frame time and the frame acquisition time, such that stationary trailer features accumulate coherently and moving objects are attenuated. Where the tow vehicle follows a curved low-speed trajectory during accumulation of the radar frames, back-projecting each accumulated radar frame may accommodate the curved trajectory without straight-line approximations, and phase compensation may be applied to each frame using an estimated radial velocity component derived from wheel encoder and inertial measurement unit data to correct for Doppler-induced phase shifts prior to azimuth processing. At least partly controlling the tow vehicle during the trailering operation may comprise controlling at least one of a trailer hitch assist system, a trailer turn collision system, a trailer reverse system, or a trailer jackknife prevention system of the tow vehicle based upon the determined one or more dimensions.

### BRIEF DESCRIPTION OF THE DRAWINGS

FIG. 1 is a schematic top view of an example tow vehicle positioned at a distance from one or more trailers disposed rearwardly of the tow vehicle.

FIG. 2 is a block diagram of an example tow vehicle including a trailer dimension measuring system according to a first example embodiment.

FIG. 3 is a flowchart illustrating a method of determining trailer dimensions using radar point cloud clustering according to the first example embodiment.

FIG. 4 is a block diagram of an example tow vehicle including a trailer dimension measuring system according to a second example embodiment utilizing synthetic aperture radar (SAR).

FIG. 5 is a flowchart illustrating a method of determining trailer dimensions using synthetic aperture radar according to the second example embodiment.

FIG. 6 illustrates radar sensor data from which the shape of a trailer tongue and trailer coupler are visible as a radar point cloud overlaid on an image of the trailer environment.

FIG. 7A illustrates a radar point cloud generated by dual rearward-facing radar sensors, depicting identification of trailer width based upon front left and front right edge clusters.

FIG. 7B illustrates a radar point cloud generated by a single rearward-facing radar sensor, depicting identification of trailer width by symmetry inference using the trailer tongue as a longitudinal axis reference.

FIG. 8 illustrates radar point cloud data projected into a bird's-eye-view occupancy grid representation, depicting the input to a trained convolutional neural network (CNN) for keypoint-based detection of trailer structural features.

FIG. 9 illustrates the structural keypoints detected by the trained neural network—including the coupler keypoint, tongue-junction keypoint, and front-left and front-right keypoints defining a T- or Y-shaped skeletal structure—overlaid on the radar point cloud together with the dimensional quantities derived therefrom.

FIG. 10 illustrates a bird's-eye-view representation used by a trailer turn collision system to estimate a path of a trailer connected to the tow vehicle and to detect potential collisions with obstacles in the estimated path.

Like reference symbols in the various drawings indicate like elements.

### DETAILED DESCRIPTION

A tow vehicle, such as, but not limited to, a car, a crossover, a truck, a van, a sports-utility-vehicle (SUV), or a recreational vehicle (RV), may be configured to tow a trailer. The tow vehicle connects to the trailer by way of a trailer hitch. Manually backing up to a trailer hitch requires the driver to continuously monitor the rearward environment and make precise steering inputs to bring the tow ball of the tow vehicle into alignment with the coupler of the trailer. Example embodiments described herein are directed to a trailer dimension measuring system that relies at least partly upon radar for identifying a trailer disposed rearwardly of a tow vehicle 100 and automatically determining pertinent dimensions of the trailer 200, without requiring manual driver input of trailer parameters. The determined trailer dimensions may be used in a number of trailer-based vehicle functions. For example, the determined dimensions may be used by a trailer hitch assist system 170 in which the trailer 200 is tracked during autonomous or semi-autonomous maneuvering of the tow vehicle 100 toward the trailer 200 for hitching. The determined dimensions may also be used in a trailer turn collision system in which the tow vehicle 100 is controlled, autonomously or semi-autonomously, while having the trailer 200 connected thereto, to avoid collisions of the trailer 200 with detected obstacles. The trailer 200 discussed herein may be any type of trailer, including a ball-hitch trailer, a fifth wheel trailer, a gooseneck trailer, a commercial trailer, or any other trailered vehicle or cargo carrier.

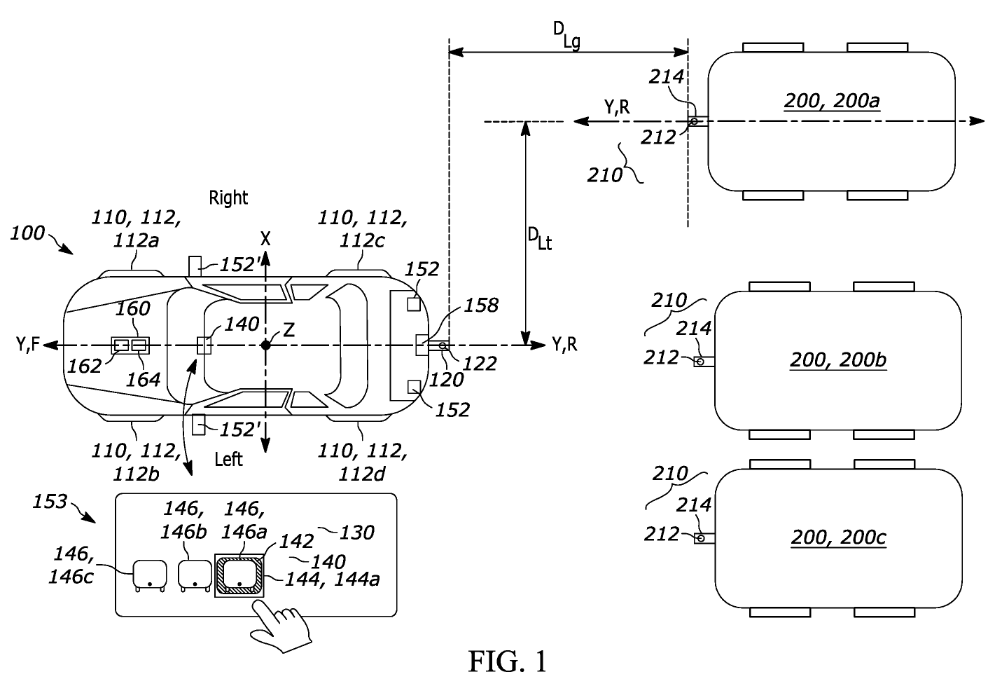

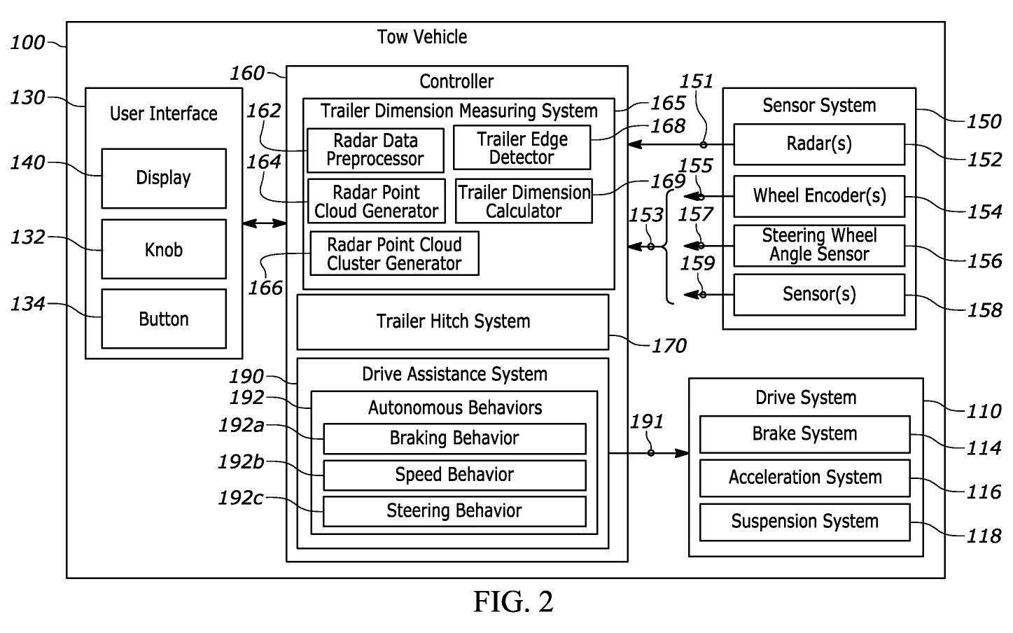

As shown in FIGS. 1 and 2, the tow vehicle 100 may include a drive system 110 that maneuvers and provides motion of the tow vehicle 100 across a road or other surface based on drive commands. The drive system 110 may include a front right wheel 112, 112a, a front left wheel 112, 112b, a rear right wheel 112, 112c, and a rear left wheel 112, 112d, though other wheel configurations are also contemplated. The drive system 110 may further include a brake system 114 comprising brakes associated with each wheel 112, 112a-d, and an acceleration system 116 configured to adjust the speed and direction of the tow vehicle 100. The drive system 110 may also include a suspension system 118 comprising tires associated with each wheel 112, 112a-d, springs, shock absorbers, and linkages that connect the tow vehicle 100 to its wheels 112, 112a-d and allow relative motion therebetween. In some implementations, the suspension system 118 may be configured to adjust the height of the tow vehicle 100, enabling a tow vehicle hitch 120 (e.g., a tow ball 122) to align with a trailer hitch 210 (e.g., a trailer hitch coupler 212 and a trailer hitch bar 214), thereby facilitating autonomous connection between the tow vehicle 100 and the trailer 200.

In some implementations, the controller 160 utilizes the tow vehicle's active suspension system 118 as an additional degree of freedom in the hitch alignment control loop. The at least one radar sensor 152 measures the height of the trailer coupler 212 relative to the tow vehicle's reference plane by estimating the coupler keypoint's vertical position from the three-dimensional radar point cloud. The controller 160 computes a height error between the detected coupler height and the nominal tow ball height. If the height error exceeds a predefined threshold, the controller 160 commands the active suspension system 118 to adjust the vehicle ride height to reduce the error before or during the final approach phase of hitch assist, thereby reducing the probability of a misalignment that would prevent successful coupling. The suspension height adjustment is coordinated with the longitudinal and lateral control commands such that suspension changes do not induce unwanted pitch or roll that would compromise coupler height estimation accuracy.

The tow vehicle 100 may move across a road or other surface through various combinations of movements relative to three mutually perpendicular axes defined by the tow vehicle 100: a transverse axis X, a fore-aft axis Y, and a central vertical axis Z. The transverse axis X extends between the right side and the left side of the tow vehicle 100. A forward drive direction along the fore-aft axis Y is designated F; a rearward drive direction along the fore-aft axis Y is designated R. When the suspension system 118 adjusts the suspension of the tow vehicle 100, the tow vehicle 100 may tilt about the X axis and/or the Y axis, or move along the central vertical axis Z.

As illustrated in the block diagram of FIG. 2, the tow vehicle 100 may include a user interface 130 comprising a display 140 and one or more input mechanisms, such as a knob 132 or a button 134. In some examples, the display 140 is a touch screen that also functions as an input mechanism. The user interface 130 receives driver commands via the input mechanisms and/or displays notifications to the driver. In some examples, the display 140 shows an image of the rearward environment of the tow vehicle 100 captured by one or more rearward-facing sensors, and the driver selects a position within the displayed image to indicate a desired target trailer. In examples where multiple trailers 200, 200a-c are detected, the display 140 may present representations 146, 146a-c of each detected trailer and allow the driver to select the desired target. In examples where only a single trailer is detected, the tow vehicle 100 may automatically identify that trailer from the rearward sensor data. The user interface 130 is in communication with a vehicle controller 160, which is in turn in communication with a sensor system 150.

When multiple trailers 200, 200a-c are detected within the region of interest, the controller 160 may automatically rank them using a weighted scoring function prior to presenting the selection to the driver. The scoring function may combine two or more of: (i) proximity, with closer trailers receiving a higher score; (ii) heading alignment, with trailers whose estimated longitudinal axis is more closely aligned with the reverse heading of the tow vehicle 100 receiving a higher score; and (iii) detection confidence, with trailers having higher keypoint or edge detection confidence receiving a higher score. The trailer receiving the highest composite score may be highlighted or pre-selected on the display 140, while remaining detected trailers are presented as selectable alternatives. The driver may confirm the pre-selected trailer or override the automatic selection by choosing an alternative from the display 140.

In some implementations, if a single trailer's composite score exceeds all other detected trailers by more than a disambiguation threshold, the controller 160 may automatically commit to that trailer without requiring driver confirmation, provided that the overall detection confidence also exceeds an autonomous-selection threshold. This fully automatic disambiguation mode may be enabled or disabled by a system setting or driver preference.

The tow vehicle 100 includes a sensor system 150 configured to provide reliable and robust perception of the surrounding environment. The sensor system 150 may include different types of sensors that may be used separately or in combination to create a comprehensive environmental perception for use in vehicle control and driver assistance decisions based on objects and obstacles detected in the surrounding environment.

With continued reference to FIGS. 1 and 2, the sensor system 150 includes one or more rearward-facing radar sensors 152 mounted on the tow vehicle 100. In some implementations, the radar sensors 152 are mounted along a rear bumper, tail light assembly, or tailgate of the tow vehicle 100 to provide radar sensor data—such as a point cloud—depicting a view of the rearward driving path of the tow vehicle 100. The radar sensors 152 are configured to determine a range, angle, and/or velocity of objects within their field of view (FOV), including the trailer 200. The radar sensors 152 transmit radio signals and measure the time it takes for a reflection of each transmitted signal to return. A distance to a detected object is determined as one-half the round-trip time multiplied by the speed of the signal. In some implementations, the radar sensors 152 may additionally determine the speed of the tow vehicle 100 relative to a stationary object based upon the change in distance to that object over successive measurement intervals.

The radar sensors 152 may include, for example, one or more Continental SxR630 79 GHz sensors having a range of approximately 10 meters and a spatial resolution of approximately 4.3 cm in a high-resolution (high bandwidth) mode. Other commercially available short-range and/or long-range radar sensors—including radar sensors having a normal operating mode and a high-bandwidth (high-resolution) mode—may also be used. As illustrated in FIG. 1, the tow vehicle 100 may include two or more rearward-facing radar sensors 152. The use of dual radar sensors 152 can improve trailer dimension estimation via triangulation techniques and can reduce occlusion by providing complementary fields of view. Additional radar sensors 152' may be disposed along the left and right side mirror assemblies of the tow vehicle 100 to further expand the rearward sensor coverage area.

In some implementations, the radar sensors 152 alternate between a first center frequency and a second center frequency higher than the first center frequency. For example, the radar sensors 152 may operate at a center frequency of approximately 77 GHz in a normal mode for initial trailer detection at a longer range, and may switch to a center frequency of approximately 79 GHz in a high-bandwidth mode as the trailer 200 is closer to the tow vehicle 100, thereby providing improved spatial resolution for edge detection and dimension calculation. This frequency-switching strategy improves both the detection range and the resolution of the sensor system 150 and of the algorithms used to process the resulting radar data.

The radar sensor 152 may be switched from the normal mode to the high-bandwidth mode based on one or more trigger conditions. In a first embodiment, the switch is distance-based: the controller 160 estimates the range to the detected trailer 200 (e.g., from the radar point cloud centroid or the coupler keypoint range) and commands the frequency switch when the estimated range falls below a predefined proximity threshold (for example, between 2 and 5 meters), at which point the shorter maximum range of the 79 GHz mode is not a limitation and the improved resolution directly benefits coupler localization accuracy. In a second embodiment, the switch is speed-based: the controller 160 monitors the tow vehicle's longitudinal speed from wheel encoders or GPS and commands the frequency switch when speed drops below a low-speed threshold commensurate with an active parking or hitch-approach maneuver (for example, below 5 or 10 km/h), thereby avoiding frequency switching during highway or normal approach driving and automatically engaging the high-resolution mode whenever the vehicle enters a slow-maneuvering regime.

In a third embodiment, the switch is confidence-based: the controller 160 monitors a coupler localization confidence metric and commands the frequency switch when confidence falls below a threshold, indicating that the 77 GHz mode resolution is insufficient for precise alignment. The trigger conditions may be combined, requiring, for example, that both the distance threshold and the speed threshold be satisfied before switching. These trigger conditions may similarly be applied in reverse to switch back from the high-bandwidth mode to the normal mode when conditions warrant, such as when distance increases above the proximity threshold or vehicle speed increases above the speed threshold.

In some implementations, the sensor system 150 additionally includes one or more non-radar sensors 158. A rear camera 158 may include a fisheye lens configured to produce an ultra-wide-angle, hemispherical image of the rearward environment of the tow vehicle 100. Images 159 captured by the rear camera 158 may be displayed on the display 140 and may include visual representations 146, 146a-c of one or more trailers 200, 200a-c positioned rearwardly of the tow vehicle 100. Other camera types capable of imaging the rearward environment of the tow vehicle 100 may also be used.

The sensor system 150 may further include one or more wheel encoders 154 associated with the wheels 112, 112a-d of the tow vehicle 100. Each wheel encoder 154 is an electromechanical device that converts the angular position or motion of its associated wheel to analog or digital output signals, thereby providing measurements of wheel speed and distance traveled. The sensor system 150 may also include a steering wheel angle sensor 156 configured to measure steering wheel data 157, such as the position angle and rate of turn of the steering wheel.

The sensor system 150 may additionally include an inertial measurement unit (IMU) configured to measure the linear acceleration of the tow vehicle 100 (via one or more accelerometers) and the rotational rate of the tow vehicle 100 (via one or more gyroscopes). In some implementations, the IMU also provides a heading reference and determines the pitch, roll, and yaw of the tow vehicle 100. Further additional sensors may include, without limitation, sonar, LIDAR (Light Detection and Ranging), LADAR (Laser Detection and Ranging), and ultrasonic sensors. These additional sensors may be rearward-facing and disposed along the rear portion of the tow vehicle 100, such as along the rear bumper or tail light assemblies thereof.

The vehicle controller 160 includes data processing hardware, such as a central processing unit comprising one or more computing processors 162, in communication with non-transitory memory 164, such as a hard disk, flash memory, or random-access memory, capable of storing instructions executable on the computing processor(s) 162. The memory 164 stores instructions for performing operations associated with the trailer dimension measuring system 165. The vehicle controller 160 may include multiple processors 162, including a processor disposed within each radar sensor 152 configured to perform initial processing on raw radar sensor data, and at least one additional processor located elsewhere in the tow vehicle 100 configured to perform further operations on the output data provided by the radar sensors 152.

Referring again to FIGS. 1 and 2, the trailer dimension measuring system 165 comprises software program instructions stored in memory 164 that, when executed by the controller 160, cause and/or configure the controller 160 to determine or otherwise measure dimensions or characteristics of the trailer 200 positioned rearwardly of the tow vehicle 100 and within the FOV of one or more of the radar sensors 152. In the first example embodiment of FIG. 2, the trailer dimension measuring system 165 includes: a radar data preprocessor 162 that performs preprocessing on raw radar data captured by the radar sensors 152; a radar point cloud generator 164 that creates one or more point clouds from the preprocessed radar sensor data; a radar point cloud cluster generator 166 that clusters points of the point cloud(s) having similar characteristics; a trailer edge detector 168 that detects edges of the trailer 200 based upon clustered cloud points corresponding to trailer edges; and a trailer dimension calculator 169 that determines dimensions of the trailer 200 based upon the detected trailer edges. The calculated dimensions of the trailer 200 may subsequently be used to perform one or more trailer-based functions by the tow vehicle 100.

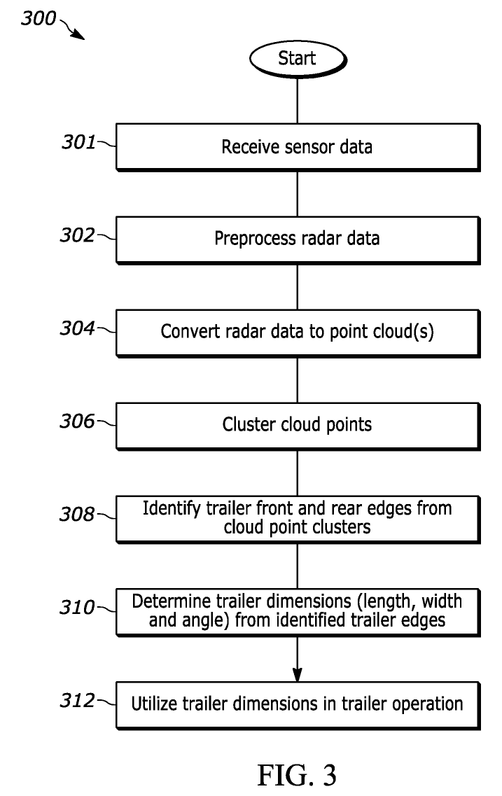

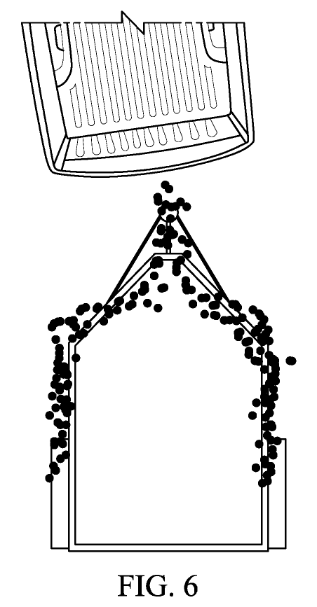

FIG. 3 illustrates a flowchart 300 of operations executed by the controller 160 for measuring dimensions of the trailer 200 according to the first example embodiment. At block 301, the controller 160 receives sensor data 151 from one or more radar sensors 152 of the sensor system 150. FIG. 6 illustrates example radar sensor data from radar sensors 152 presented as a point cloud overlaid on a top-view image of the tow vehicle 100 and trailer 200, in which the trailer tongue and coupler are visible as distinctive point cloud features. The received sensor data is described below for simplicity as sensor data from multiple radar sensors 152 and, optionally, additional sensors 152'.

At block 302, the radar data preprocessor 162 is executed by the controller 160 to preprocess the received radar sensor data. Preprocessing retains only stationary or near-stationary radar detections within a predetermined region of interest and filters out ghost objects and spurious detections using multiple complementary mechanisms described herein. Limiting the radar data to stationary or near-stationary detections is particularly advantageous in cold-start hitching scenarios where the trailer 200 is stationary relative to the ground before the tow vehicle 100 begins reversing. This preprocessing step reduces noise and clutter in the radar data and improves the accuracy of subsequent edge detection and dimension estimation operations.

A first ghost-object suppression mechanism is Doppler velocity gating, which rejects radar detections whose radial velocity relative to the ego vehicle exceeds a threshold commensurate with a stationary or near-stationary target. Because multipath and spurious ghost reflections often carry anomalous Doppler signatures inconsistent with a static reflector, Doppler gating provides a first-stage rejection of dynamic clutter without relying on amplitude thresholds. The Doppler threshold may be set as a function of ego vehicle speed to account for residual motion of nominally stationary targets caused by vehicle vibration or IMU velocity error. A second mechanism is cross-frame temporal persistence filtering, which retains only detections that appear in at least N of M successive radar frames at a consistent spatial location within a position tolerance epsilon. Genuine trailer returns persist across frames because the trailer is stationary; ghost returns arising from single-frame multipath events, thermal noise spikes, or electronic interference do not persist at a consistent spatial location and are therefore rejected by this filter. The values of N, M, and epsilon may be calibrated based on the radar update rate and expected ego-vehicle motion during the accumulation window.

A third ghost-object suppression mechanism is Constant False Alarm Rate (CFAR) adaptive thresholding, which sets the detection amplitude threshold relative to the local noise floor estimated from neighboring range-Doppler cells. Unlike fixed-amplitude thresholding, CFAR adapts to varying clutter environments (e.g., wet asphalt, metal fencing, other parked vehicles), maintaining a statistically defined false alarm probability while suppressing ghost returns generated by strong nearby reflectors. The CFAR algorithm may be implemented as a cell-averaging CFAR (CA-CFAR), ordered-statistics CFAR (OS-CFAR), or a variant suited to the automotive radar signal processing pipeline.

A fourth mechanism is spatial region-of-interest (ROI) gating, which rejects all detections outside a predefined rearward region defined by a maximum range, a minimum range, and a lateral angular extent. The ROI is parameterized to encompass trailers within the expected coupling range and angular offset while excluding detections from adjacent vehicles, roadside infrastructure, and other off-axis clutter sources. The combination of Doppler gating, temporal persistence filtering, CFAR thresholding, and ROI gating operates as a cascade, with each stage reducing the false-detection population presented to downstream clustering and edge-identification stages. Collectively, these mechanisms distinguish the presently disclosed preprocessing approach from prior art that relies solely on amplitude histogram filtering or yaw-rate-dependent filtering.

At block 304, the controller 160 executes instructions of the radar point cloud generator 164 and converts the preprocessed radar data to at least one radar point cloud. A point cloud is a collection of discrete data points representing detected objects within the range of the corresponding radar sensors 152. Each point in the cloud corresponds to a location in three-dimensional (3D) space where a radar signal reflected from an object was detected. In some implementations, each radar sensor 152 outputs an individual point cloud corresponding to its respective FOV, and the individual point clouds from the multiple radar sensors 152 may be combined or fused to form a single unified point cloud for subsequent processing.

At block 306, the controller 160 executes instructions of the radar point cloud cluster generator 166 and clusters the cloud points in order to identify and separate trailer edges from background detections. Data clustering groups similar radar points together to identify and track objects of interest. Cloud points may be clustered based upon spatial proximity, velocity similarity, SNR, or other features. Data clustering separates reflections from individual objects from cloud points corresponding to noise or clutter, enabling better identification and tracking of trailer features. Each cloud point may represent a detection and may include attributes such as three-dimensional coordinates, velocity, and signal-to-noise ratio (SNR). Clustering algorithms such as k-means clustering or Density-Based Spatial Clustering of Applications with Noise (DBSCAN) may be applied to cluster the radar cloud points and separate edges of the trailer 200 from noisy cloud points. The data clustering of the radar-based point cloud results in clustered cloud points corresponding to edges of the trailer 200.

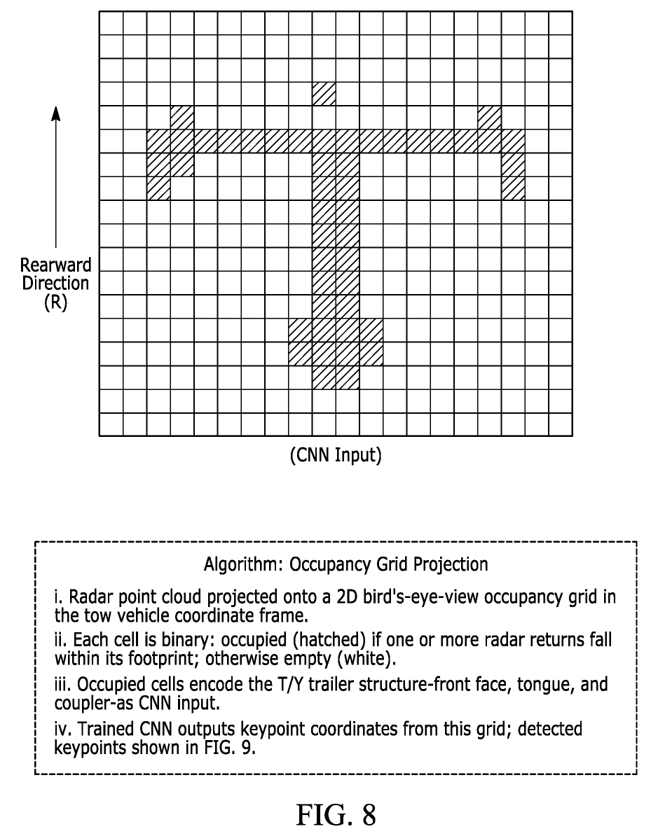

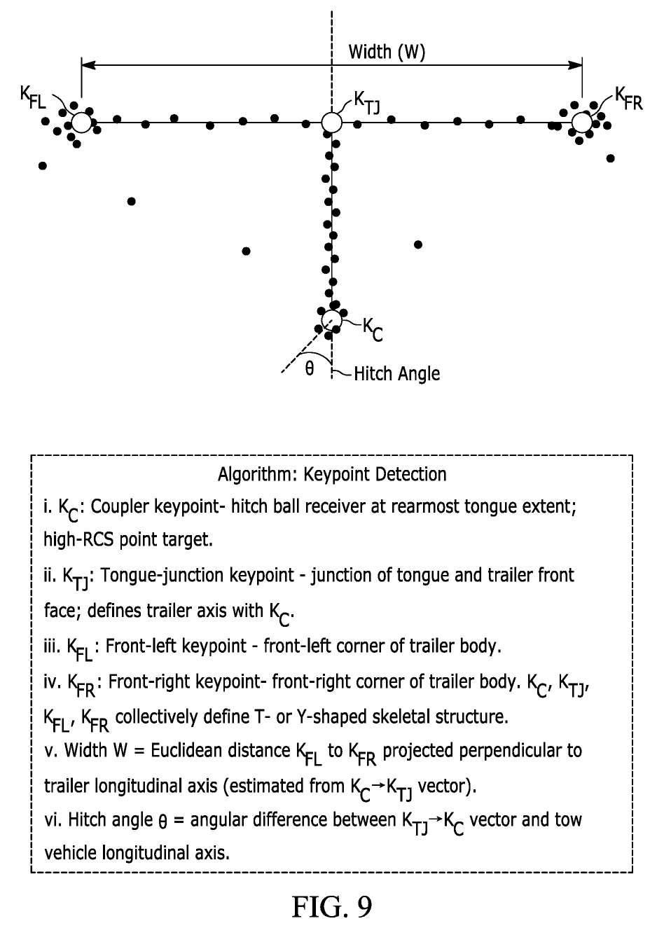

At block 308, the controller 160 identifies, by executing instructions of the trailer edge detector 168, the corresponding edges of the trailer 200. The trailer edge detector 168 may detect trailer edges based at least in part upon the relative locations of the clustered cloud points. The trailer edges identified may include a front left edge and a front right edge of the trailer 200, and, in some implementations, at least one rear edge (left or right) of the trailer 200. Key point detection may additionally be employed, as illustrated in FIGS. 8 and 9, to identify structural keypoints of the trailer 200 from the radar sensor data, as described in detail below.

As illustrated in FIGS. 8 and 9, the controller 160 may identify a set of structural keypoints on the trailer 200 using a trained machine-learning model, such as a convolutional neural network (CNN) or a point-cloud neural network (e.g., PointNet or a derivative architecture), applied to the radar point cloud or to a range-azimuth or range-Doppler map derived therefrom. The keypoints exploit a topological feature common to substantially all tongue-pull trailer types: the tongue of the trailer forms a longitudinal centerline member that (i) terminates rearward at the coupler 212 and (ii) meets the trailer front face at a junction. The coupler 212, the tongue-to-front-face junction, the front-left trailer corner, and the front-right trailer corner together define a T-shaped or Y-shaped skeletal structure that is present on essentially every tongue-pull trailer regardless of manufacturer, body style, or dimension. This structural invariance makes the T/Y skeleton a robust detection target that generalizes across the trailer population without retraining for each trailer type.

The set of keypoints detected may include, without limitation: (a) a coupler keypoint, corresponding to the hitch ball receiver at the rearmost extent of the tongue and constituting a high-radar-cross-section point target due to the concave metallic geometry of the coupler 212; (b) a tongue-junction keypoint, corresponding to the location at which the trailer tongue meets the trailer front face; (c) a front-left keypoint, corresponding to the front left corner or edge of the trailer body; and (d) a front-right keypoint, corresponding to the front right corner or edge of the trailer body. Each keypoint is associated with a predicted (x, y) position in the vehicle-relative coordinate frame and an associated confidence score output by the model.

The controller 160 may compute trailer dimensions directly from the detected keypoints. As used herein, the terms "hitch angle" and "trailer angle" are used interchangeably to refer to the angular relationship between the longitudinal axis of the tow vehicle and the longitudinal axis of the trailer. Trailer width is computed as the Euclidean distance between the front-left keypoint and the front-right keypoint projected onto an axis perpendicular to the estimated trailer longitudinal axis. The trailer longitudinal axis is estimated from the vector connecting the coupler keypoint to the tongue-junction keypoint. The hitch angle between the tow vehicle longitudinal axis and the trailer longitudinal axis is computed as the angular difference between the trailer longitudinal axis vector and the vehicle heading obtained from the IMU or steering sensor. The coupler keypoint position provides a direct hitch-alignment target for use by the vehicle control system and the trailer hitch assist system 170. Optionally, trailer length may be estimated by combining the front-face position derived from the front-left and front-right keypoints with rear-edge detections obtained from the point cloud or SAR pipeline.

The machine-learning model may be trained on labeled radar datasets in which ground-truth keypoint positions are annotated using manual annotation or automatic annotation with a secondary sensor (e.g., LiDAR or camera). Data augmentation may include simulated variations in trailer orientation, distance, radar noise level, environmental conditions, and reflectivity. During inference at runtime, the model receives a preprocessed radar point cloud or radar image representation as input and outputs keypoint coordinates and confidence scores within a latency budget compatible with real-time hitch assist control. As illustrated in FIG. 8, the input point cloud may be projected into a bird's-eye-view occupancy grid to form a two-dimensional image-like representation suitable for standard CNN architectures, and FIG. 9 illustrates the resulting detected keypoints overlaid on the point cloud together with the derived dimensional quantities.

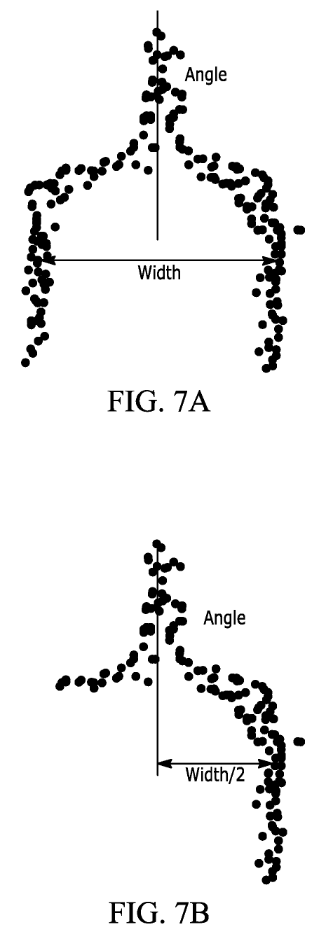

At block 310, based upon the detected trailer edges, the controller 160 determines one or more dimensions or other characteristics of the trailer 200. For example, the trailer dimension calculator 169 may calculate the width of the trailer 200 based upon the identified front left and front right edges of the trailer 200, and in particular the distance between those edges. FIG. 7A illustrates a radar point cloud from dual radar sensors 152, from which the trailer width is calculated as the distance between the cluster of cloud points associated with the front left edge of the trailer 200 and the cluster associated with the front right edge of the trailer 200.

In some implementations using a single radar sensor 152, trailer width may be determined by symmetry inference without requiring independent detection of both front lateral edges. FIG. 7B illustrates how a single radar sensor 152 may produce a radar point cloud from which trailer width is determined. The clustering of the radar point cloud from the single radar sensor may identify both a single front edge (left or right) of the trailer 200 and the trailer tongue, which corresponds to the longitudinal axis of the trailer. Because a trailer typically exhibits bilateral lateral symmetry about its longitudinal axis, the trailer width may be determined as twice the distance between the trailer's longitudinal axis (identified from the trailer tongue cluster) and the clustered cloud points corresponding to the identified front edge. This symmetry-based approach enables accurate trailer width determination from a single rearward-facing radar sensor, even in cold-start conditions and even when one lateral side of the trailer is partially occluded.

The trailer dimension calculator 169 may also determine the length of the trailer 200 based at least in part upon a front edge (left or right) and a corresponding rear edge of the trailer 200. Further, for a trailer 200 in a pre-hitching standstill or connected to the tow vehicle 100, the trailer dimension calculator 169 may configure the controller 160 to determine the trailer angle—the angle formed between the longitudinal axis of the tow vehicle 100 (the fore-aft axis Y, passing through the tow ball 122) and the longitudinal axis of the trailer (passing through the tow ball 122 and/or the coupler 212 of the trailer 200). The trailer angle may be determined based upon, for example, the locations of the front left and front right edges detected in block 308, and in particular the locations of those front edges relative to the radar sensors 152 and/or the tow ball 122.

In one embodiment, the controller 160 determines the hitch angle by fitting a geometric line model to the radar points associated with the front face of the trailer 200, as identified by the edge-clustering step. Robust line fitting, such as Random Sample Consensus (RANSAC) or ordinary least-squares regression applied to the front-face point cluster, yields a line whose orientation in the vehicle-relative coordinate frame defines the trailer's transverse axis. The hitch angle is then computed as ninety degrees minus the angle between this fitted transverse axis and the tow vehicle longitudinal axis obtained from the IMU heading or steering sensor. RANSAC fitting is preferred in environments with significant multipath clutter because it is resistant to outlier points that do not belong to the true trailer front face.

In a second embodiment, the hitch angle is derived directly from the keypoint-based representation described above. The vector from the tongue-junction keypoint to the coupler keypoint defines the trailer longitudinal axis in the vehicle-relative frame. The hitch angle is computed as the signed angular difference between this vector and the tow vehicle's longitudinal axis. This approach does not require a separate line-fitting step and is more computationally efficient when the keypoint model is already executing for coupler localization. The confidence scores associated with the coupler keypoint and the tongue-junction keypoint may be used to weight the angle estimate or to gate its use in the vehicle control loop.

Unlike camera-based hitch angle estimation techniques, which rely on visual markers or painted reference patterns on the trailer tongue and are degraded by darkness, rain, fog, or direct glare, the radar-based angle computation described herein operates in all lighting and weather conditions without modification and does not require any trailer modification or marking, making it suitable for use with unmodified commercial trailers across a wide range of operating environments.

At block 312, following determination of the trailer dimensions, the controller 160 is configured to provide, transmit, or otherwise make available the determined trailer dimensions for use by the trailer hitch assist system 170, a trailer turn collision system, a trailer reverse system (and/or trailer jackknife prevention system), a trailer lane change system, or other trailering functions. Such use may cause the controller 160 or other controllers in the tow vehicle 100 to perform autonomous or semi-autonomous vehicle operation based upon the determined trailer dimensions.

To prevent transient or unstable measurements from being used by downstream hitch assist and collision avoidance systems, the controller 160 may implement a dimension commitment gate. Under this gate, trailer dimension estimates—including width, length, hitch angle, and coupler position—are not committed to the vehicle control system until the estimates have remained within a predefined variance band across a minimum number of successive measurement cycles, for example, at least three consecutive radar frames or SAR accumulation windows. If the estimates are consistent across the required number of cycles, the controller 160 commits the dimensions and enables autonomous or semi-autonomous actuation. If consistency is not achieved within a timeout period, the controller 160 may fall back to requesting driver input or may continue accumulating data before reattempting commitment.

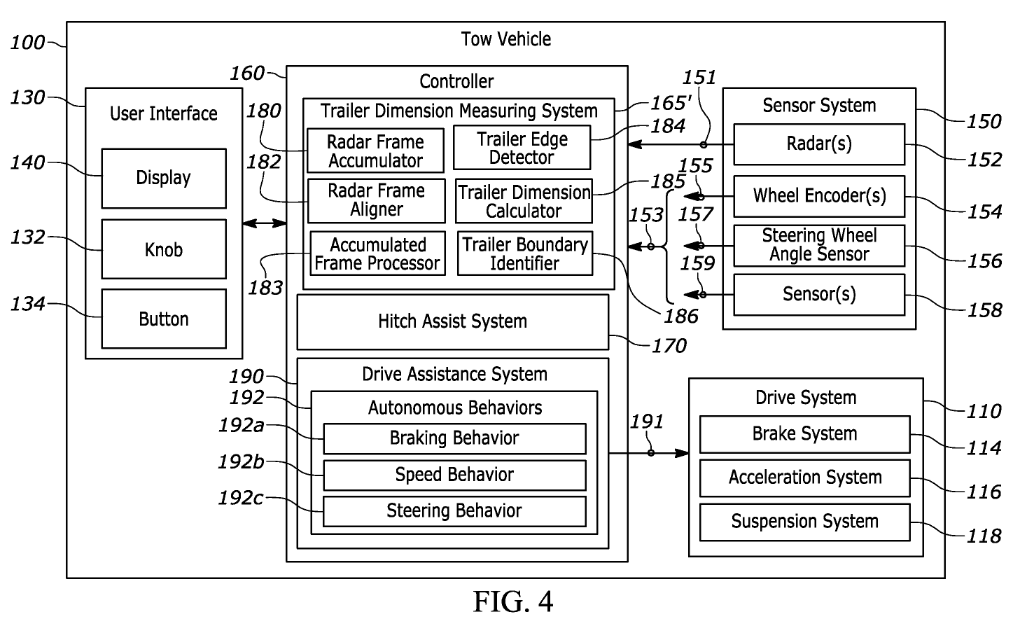

According to a second example embodiment, the trailer dimension measuring system 165' configures the tow vehicle controller 160 to determine one or more trailer dimensions using synthetic aperture radar (SAR). As shown in FIG. 4, the trailer dimension measuring system 165' includes software program modules that, when executed by the controller 160, cause the controller 160 to determine dimensions of the trailer 200. Specifically, the trailer dimension measuring system 165' includes: a radar frame accumulator 180 that configures the controller 160 to accumulate radar frames at various time intervals; a radar frame aligner 182 that configures the controller 160 to align the accumulated frames using odometry data obtained from, for example, the tow vehicle IMU and/or GPS system; an accumulated frame processor 183 that configures the controller 160 to coherently process the accumulated, aligned radar frames to improve spatial resolution; a trailer edge detector 184 that configures the controller 160 to extract edges of the trailer 200 from the processed, accumulated, and aligned radar frames; a trailer boundary identifier 186 that configures the controller 160 to determine trailer boundaries from the processed accumulated frames; and a trailer dimension calculator 185 that determines dimensions of the trailer 200 based upon the extracted edges and/or determined boundaries.

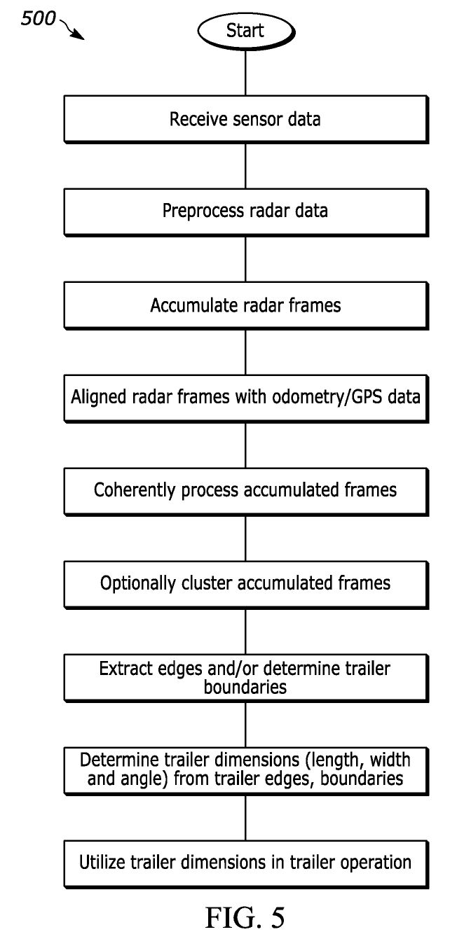

FIG. 5 illustrates a flowchart for determining trailer dimensions according to the second example embodiment of FIG. 4. Following reception and preprocessing of radar sensor data, the controller 160 accumulates radar frames over a plurality of time intervals. The accumulated radar frames are aligned with odometry data provided by, for example, the tow vehicle IMU and/or GPS system. The accumulated, aligned radar frames are coherently processed by the configured controller 160 to provide improved spatial resolution over that available from individual radar frames. Clustering of the radar data in the accumulated, aligned, and processed radar frames may optionally be performed. Edges of the trailer 200 are detected based upon the (optionally) clustered, accumulated, aligned, and processed radar frames. Alternatively, trailer boundaries are determined using, for example, a convex hull algorithm based upon the processed accumulated frames. Dimensions of the trailer 200 are then determined based upon the extracted edges and/or determined trailer boundaries, and are provided to trailer-based vehicle control systems.

To align accumulated radar frames into a common reference frame, the controller 160 estimates the tow vehicle's two-dimensional pose (position and heading) at each frame acquisition time using a sensor fusion estimator, such as a Kalman filter or complementary filter, that integrates wheel encoder velocity, steering angle, and IMU angular rate data. The resulting pose trajectory defines the vehicle's path through the accumulation window with a temporal resolution equal to the radar frame rate. Each accumulated radar frame is then geometrically back-projected: the range-azimuth data from each frame is translated and rotated into the common reference frame using the inverse of the pose change between the reference frame time and the frame acquisition time. This back-projection step ensures that stationary scene points—including trailer features—accumulate coherently while moving objects spread across multiple range-azimuth cells and are thereby attenuated in the accumulated output.

Unlike prior art SAR systems designed primarily for straight-line or highway-speed trajectories, the present system operates in low-speed parking and hitch-approach scenarios where the vehicle trajectory is typically curved as the driver maneuvers toward the trailer. The pose-based back-projection approach accommodates arbitrary low-speed curved trajectories without the approximations inherent to straight-line SAR formulations, making it suitable for the stop-and-go motion profiles encountered during hitch assist. Phase compensation may additionally be applied to each frame using the estimated radial velocity component derived from the wheel encoder and IMU data, correcting for Doppler-induced phase shifts across the coherent accumulation window before the azimuth FFT is performed. This combination of pose-based geometric back-projection and phase compensation provides improved spatial resolution of trailer features under the curved, low-speed approach conditions characteristic of trailer hitching maneuvers.

In one implementation of the second example embodiment, the trailer dimension measuring system 165' optionally clusters the radar data in the accumulated, aligned radar frames such that the trailer edge detector 184 detects edges of the trailer 200 from the clustered radar data. In another implementation, trailer boundaries may be determined using a convex hull algorithm based upon the processed, accumulated, and aligned radar frames. In yet another implementation, the trailer edge detector 184 may utilize machine learning and/or artificial intelligence through use of a neural network to detect the trailer edges from the processed accumulated frames.

A number of techniques may be utilized in the second example embodiment to provide improved radar resolution from the coherent processing of accumulated radar frames. For example, one or more Fast Fourier Transforms (FFTs) may be applied, including a range FFT, a Doppler FFT that analyzes Doppler frequency shifts in the radar signals, or an FFT that analyzes signals in both range and azimuth dimensions simultaneously. Resolution estimation methods such as MUSIC (MUltiple SIgnal Classification) or ESPRIT (Estimation of Signal Parameters via Rotational Invariance Technique) may also be utilized to further improve spatial resolution.

According to another example embodiment, sensor data 153 from additional sensors—such as wheel encoders 154, the steering wheel angle sensor 156, and/or other sensors 158—may be used to improve the trailer dimension calculations described above through sensor fusion. For example, sensor fusion utilizing a Kalman filter may help refine the estimated shape of the trailer 200 by combining radar-derived geometric estimates with motion-model predictions derived from wheel odometry or IMU data, thereby improving accuracy and stability of the dimension estimates over time.

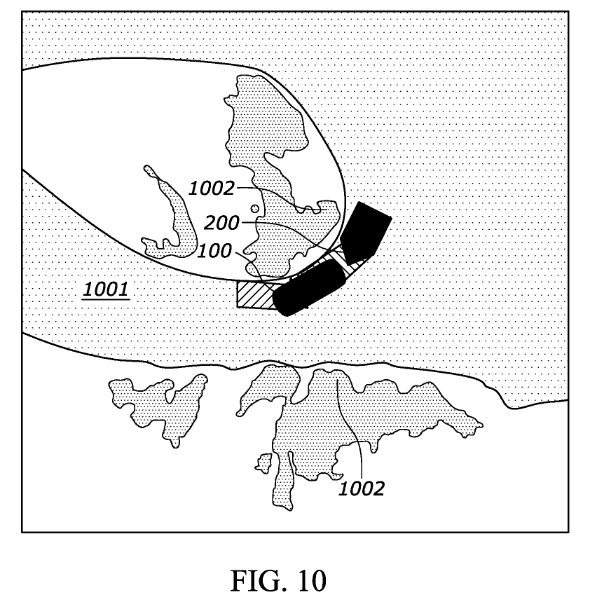

FIG. 10 illustrates an aspect of a trailer turn collision system of the tow vehicle 100. The illustration depicts a bird's-eye view representation of a roadway 1001 on which the tow vehicle 100 and a connected trailer 200 travel. Tow vehicle 100, connected trailer 200, and detected objects or obstructions 1002 are depicted in the representation. The trailer turn collision system uses the determined trailer dimensions (particularly trailer width and length) to estimate the swept path of the trailer 200 during turning maneuvers of the tow vehicle 100, and takes responsive action upon determining that the estimated trailer path will intersect a detected object or obstruction 1002. Responsive action may include controlling the steering and/or speed and acceleration of the tow vehicle 100 to avoid a collision of the trailer 200 with the detected object/obstruction 1002, and/or controlling the user interface 130 to warn the operator to take corrective action to avoid the detected object/obstruction.

Various implementations of the systems and techniques described in this specification can be realized in digital electronic circuitry, integrated circuitry, specially designed application-specific integrated circuits (ASICs), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the terms 'machine-readable medium' and 'computer-readable medium' refer to any computer program product, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term 'machine-readable signal' refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Subject matter described in this specification can be implemented as one or more computer program products—i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The terms 'data processing apparatus' and 'computing processor' encompass all apparatus, devices, and machines for processing data, including by way of example a programmable processor, a computer, or multiple processors or computers.

While operations are depicted in the drawings in a particular order, this should not be understood as requiring that such operations be performed in the particular order shown or in sequential order, or that all illustrated operations must be performed to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

1. A method of determining dimensions of a trailer positioned rearwardly of a tow vehicle, the method comprising:
receiving, by data processing hardware, sensor data from at least one radar sensor mounted on a rearward-facing portion of the tow vehicle;
accumulating, by the data processing hardware, radar frames based upon the sensor data over a plurality of time intervals;
aligning, by the data processing hardware, the accumulated radar frames using odometry data of the tow vehicle;
coherently processing, by the data processing hardware, the aligned accumulated radar frames to provide improved spatial resolution;
extracting, by the data processing hardware, one or more edges or boundaries of the trailer from the coherently processed radar frames;
determining, by the data processing hardware, one or more dimensions of the trailer based upon the extracted one or more edges or boundaries; and
at least partly controlling the tow vehicle during a trailering operation based upon the determined one or more dimensions of the trailer.

2. The method of claim 1, further comprising clustering radar data in the aligned accumulated radar frames prior to extracting the one or more edges or boundaries of the trailer.

3. The method of claim 1, wherein extracting the one or more boundaries of the trailer comprises applying a convex hull algorithm to the coherently processed radar frames to determine the boundaries of the trailer.

4. The method of claim 1, wherein extracting the one or more edges of the trailer comprises applying a neural network to the coherently processed radar frames to detect the one or more edges.

5. The method of claim 1, wherein coherently processing the aligned accumulated radar frames comprises applying one or more Fast Fourier Transforms (FFTs) to the accumulated radar frames, the one or more FFTs comprising at least one of a range FFT, a Doppler FFT, or a combined range-azimuth FFT.

6. The method of claim 1, wherein aligning the accumulated radar frames comprises:
estimating a two-dimensional pose of the tow vehicle at each frame acquisition time using a sensor fusion estimator that integrates wheel encoder velocity, steering angle data, and inertial measurement unit angular rate data; and
back-projecting each accumulated radar frame into a common reference frame using an inverse of a pose change between a reference frame time and the frame acquisition time, such that stationary trailer features accumulate coherently and moving objects are attenuated.

7. The method of claim 6, wherein the tow vehicle follows a curved low-speed trajectory during accumulation of the radar frames, and wherein back-projecting each accumulated radar frame accommodates the curved trajectory without straight-line approximations, the method further comprising applying phase compensation to each frame using an estimated radial velocity component derived from wheel encoder and inertial measurement unit data to correct for Doppler-induced phase shifts prior to azimuth processing.

8. A system for determining dimensions of a trailer positioned rearwardly of a tow vehicle, the system comprising:
at least one radar sensor configured to be mounted on a rearward-facing portion of the tow vehicle and to generate radar sensor data representing a rearward environment of the tow vehicle;
data processing hardware; and
non-transitory memory storing instructions that, when executed by the data processing hardware, cause the data processing hardware to perform operations comprising:
accumulating radar frames based upon the radar sensor data over a plurality of time intervals;
aligning the accumulated radar frames using odometry data of the tow vehicle;
coherently processing the aligned accumulated radar frames to provide improved spatial resolution;
extracting one or more edges or boundaries of the trailer from the coherently processed radar frames;
determining one or more dimensions of the trailer based upon the extracted one or more edges or boundaries; and
at least partly controlling the tow vehicle during a trailering operation based upon the determined one or more dimensions.

9. The method of claim 1, wherein at least partly controlling the tow vehicle during the trailering operation comprises controlling at least one of a trailer hitch assist system, a trailer turn collision system, a trailer reverse system, or a trailer jackknife prevention system of the tow vehicle based upon the determined one or more dimensions.
